(19) United States
(12) Patent Application Publication
(10) Pub. No.: US 2026/0129566 A1
(43) Pub. Date: May 7, 2026

(54) TRUSTED NON-3GPP ACCESS NETWORK SELECTION

(71) Applicant: Intel Corporation, Santa Clara, CA (US)

(72) Inventor: Thomas LUETZENKIRCHEN, Taufkirchen (DE)

(21) Appl. No.: 19/116,267

(22) PCT Filed: Oct. 25, 2023
(86) PCT No.: PCT/US2023/035842

§ 371 Date: Mar. 27, 2025

Related U.S. Application Data
(60) Provisional application No. 63/421,072, filed on Oct. 31, 2022.

(51) Int. Cl. H04W 48/18; H04W 12/08; H04W 48/16; H04W 84/12

(52) U.S. Cl. CPC H04W 48/18; H04W 12/08; H04W 48/16; H04W 84/12

(57) ABSTRACT

The application relates to trusted non-3GPP access network selection. Apparatus for trusted non-3GPP access network selection is used in User Equipment (UE) and includes processor circuitry configured to cause the UE to, when the UE is operating in Stand-alone Non-Public Network (SNPN) access mode: receive, from a Wireless Local Area Network (WLAN), an Access Network Query Protocol (ANQP) information element, wherein the ANQP information element is an SNPN list with trusted 5G connectivity information element indicating one or more SNPNs with trusted 5G connectivity that can be selected from the WLAN; and select, based on the SNPN list with trusted 5G connectivity information element, a SNPN with trusted 5G connectivity for trusted non-3GPP access to a 5G Core (5GC) network.

### CROSS REFERENCES TO RELATED APPLICATIONS

This application is based on and claims priority to U.S. patent application No. 63/421,072 filed on Oct. 31, 2022, which is incorporated herein by reference in its entirety.

### TECHNICAL FIELD

Embodiments of the disclosure generally relate to wireless communications, and in particular to an apparatus for trusted non-3GPP access network selection.

### Background Art

Mobile communication has evolved significantly from early voice systems to today's highly sophisticated integrated communication platform. The 5G or New Radio (NR) wireless communication system will provide access to information and sharing of data anywhere, anytime by various users and applications.

### BRIEF DESCRIPTION OF THE DRAWINGS

Embodiments of the disclosure will be illustrated, by way of example and not limitation, in the accompanying drawings in which like reference numerals refer to similar elements.

FIG. 1 illustrates a diagram of an example scenario for trusted non-3GPP access network selection in accordance with some embodiments of the disclosure.

FIG. 2 illustrates a flow diagram of a method for trusted non-3GPP access selection in accordance with some embodiments of the disclosure.

FIG. 3 illustrates a diagram of an example format of an SNPN list with trusted 5G connectivity information element in accordance with some embodiments of the disclosure.

FIG. 4 illustrates a diagram of an example format of an SNPN information list field in accordance with some embodiments of the disclosure.

FIG. 5A illustrates a diagram of an example format of an SNPN information entry field in accordance with some embodiments of the disclosure.

FIG. 5B illustrates a diagram of an example format of an SNPN identity or identifier field in accordance with some embodiments of the disclosure.

FIG. 5C illustrates a diagram of an example format of an SNPN access information field in accordance with some embodiments of the disclosure.

FIG. 5D illustrates a diagram of an example format of the supported GINs field in accordance with some embodiments of the disclosure.

FIG. 6A illustrates a diagram of an example format of a GIN list field in accordance with some embodiments of the disclosure.

FIG. 6B illustrates a diagram of an example format of a GIN information entry field in accordance with some embodiments of the disclosure.

FIG. 6C illustrates a diagram of an example format of a NID list in accordance with some embodiments of the disclosure.

FIG. 6D illustrates a diagram of an example format of the NID identity in accordance with some embodiments of the disclosure.

FIG. 7 illustrates a diagram of a network in accordance with various embodiments of the disclosure.

FIG. 8 illustrates a diagram of a wireless network in accordance with various embodiments of the disclosure.

FIG. 9 illustrates a block diagram of components, in accordance with various embodiments of the disclosure, able to read instructions from a machine-readable or computer-readable medium (e.g., a non-transitory machine-readable storage medium) and perform any one or more of the methodologies discussed herein.

### DETAILED DESCRIPTION OF EMBODIMENTS

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

Currently, enhancements are made to the 5G wireless communication system to enable trusted and untrusted non-3GPP access in a Stand-alone Non-Public Network (SNPN). However, only untrusted non-3GPP access is supported in Public Land Mobile Networks (PLMNs).

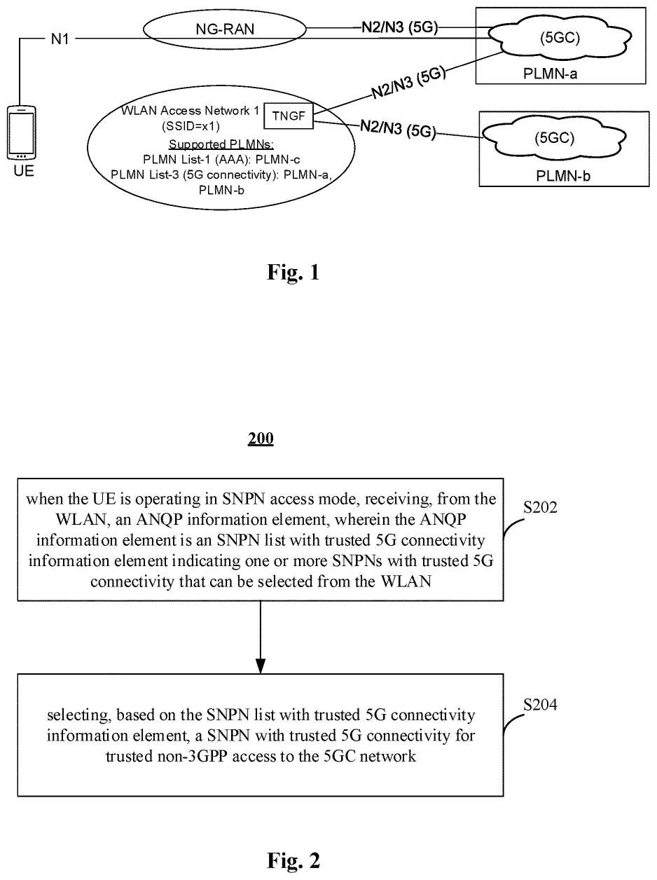

In view of the above, a method for trusted non-3GPP access network selection is proposed to support trusted non-3GPP access in PLMNs. FIG. 1 illustrates a diagram of an example scenario for trusted non-3GPP access network selection in accordance with some embodiments of the disclosure. As shown in FIG. 1, User Equipment (UE) may select, via a Wireless Local Area Network (WLAN), one from multiple Stand-alone Non-Public Networks (SNPNs) with trusted 5G connectivity for trusted non-3GPP access to a 5G Core (5GC) network.

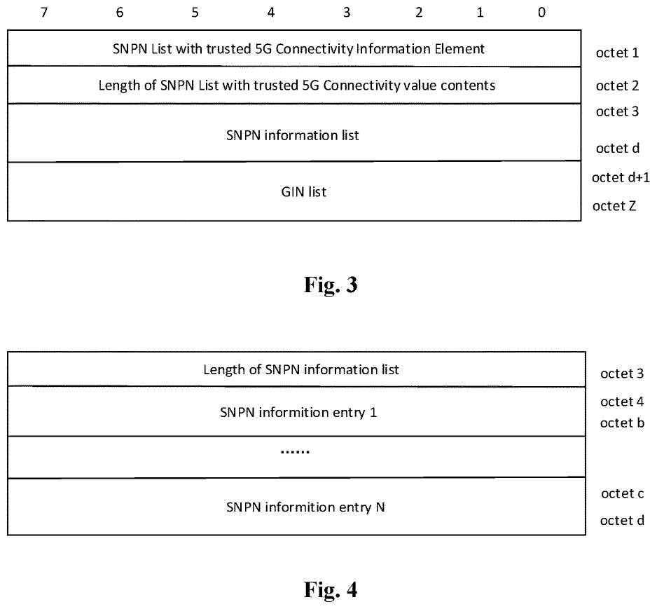

FIG. 2 illustrates a flow diagram of a method for trusted non-3GPP access selection in accordance with some embodiments of the disclosure. The method 200 for trusted non-3GPP access selection shown in FIG. 2 may be used in the UE and include, when the UE is operating in SNPN access mode: S202, receiving, from the WLAN, an Access Network Query Protocol (ANQP) information element, wherein the ANQP information element is an SNPN list with trusted 5G connectivity information element indicating one or more SNPNs with trusted 5G connectivity that can be selected from the WLAN; and S204, selecting, based on the SNPN list with trusted 5G connectivity information element, a SNPN with trusted 5G connectivity for trusted non-3GPP access to the 5GC network. That is to say, the SNPN list with trusted 5G connectivity information element may be used by the WLAN to indicate the SNPNs with trusted 5G connectivity that can be selected from the WLAN, and may be used by the UE to select, via the WLAN, the SNPN with trusted 5G connectivity for trusted non-3GPP access to the 5GC network.

In some embodiments, the SNPN list with trusted 5G connectivity information element contains a SNPN identifier associated with each of the one or more SNPNs with trusted 5G connectivity that can be selected from the WLAN.

In some embodiments, the SNPN list with trusted 5G connectivity information element contains one or more Group Identifiers for Network selection (GINs) supported by each of the one or more SNPNs with trusted 5G connectivity that can be selected from the WLAN.

In some embodiments, the SNPN list with trusted 5G connectivity information element contains SNPN access information associated with each of the one or more SNPNs with trusted 5G connectivity that can be selected from the WLAN.

In some embodiments, the SNPN list with trusted 5G connectivity information element contains, for each of the one or more SNPNs with trusted 5G connectivity that can be selected from the WLAN, information indicating whether the SNPN supports access using credentials from a credentials holder.

In some embodiments, the SNPN list with trusted 5G connectivity information element contains, for each of the one or more SNPNs with trusted 5G connectivity that can be selected from the WLAN, information indicating whether the SNPN allows registration attempts with credentials from a credentials holder from UEs that are not explicitly configured to select the SNPN.

In some embodiments, the SNPN list with trusted 5G connectivity information element contains, for each of the one or more SNPNs with trusted 5G connectivity that can be selected from the WLAN, information indicating whether the SNPN supports SNPN onboarding services.

In some embodiments, the SNPN list with trusted 5G connectivity information element contains, for each of the one or more SNPNs with trusted 5G connectivity that can be selected from the WLAN, information indicating whether the SNPN supports emergency services.

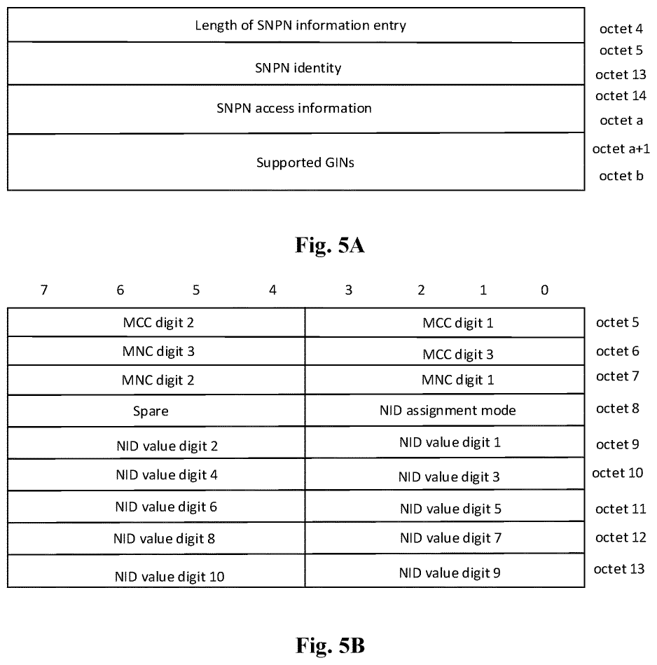

FIG. 3 illustrates a diagram of an example format of the SNPN list with trusted 5G connectivity information element in accordance with some embodiments of the disclosure. As shown in FIG. 3, the SNPN list with trusted 5G connectivity information element includes an information element identity or identifier field, a length of SNPN list with trusted 5G connectivity value contents field, an SNPN information list field, and a GIN list field, wherein information relevant to the one or more SNPNs with trusted 5G connectivity that can be selected from the WLAN may be contained in the SNPN information list field, and information relevant to the one or more GINs supported by each of the one or more SNPNs with trusted 5G connectivity that can be selected from the WLAN may be contained in the GIN list field.

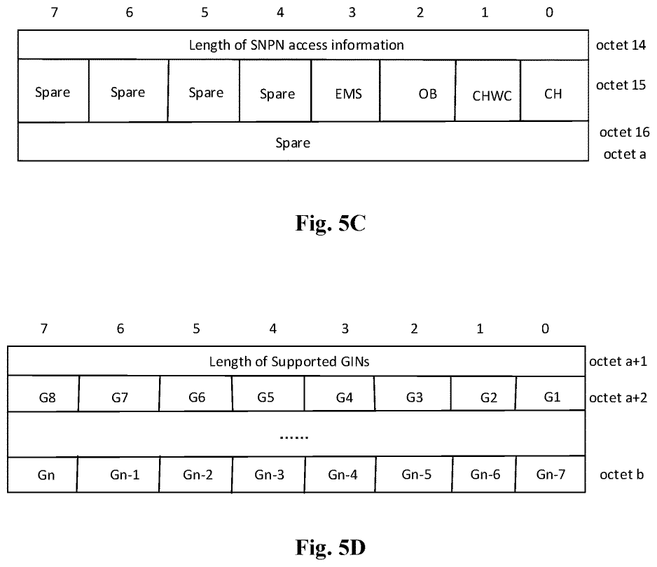

FIG. 4 illustrates a diagram of an example format of the SNPN information list field in accordance with some embodiments of the disclosure. As shown in FIG. 4, the SNPN information list field includes a length of SNPN information list field and one or more SNPN information entry fields, wherein information relevant to one of the one or more SNPNs with trusted 5G connectivity that can be selected from the WLAN may be contained in one of the one or more SNPN entry fields.

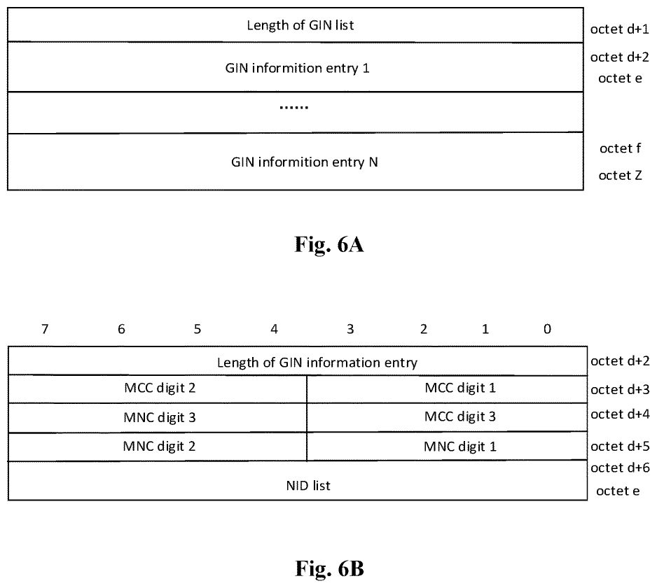

FIG. 5A illustrates a diagram of an example format of the SNPN information entry field in accordance with some embodiments of the disclosure. As shown in FIG. 5A, the SNPN information entry field includes a length of SNPN information entry field, an SNPN identity or identifier field, and a supported GINs field. FIG. 5B illustrates a diagram of an example format of the SNPN identity or identifier field in accordance with some embodiments of the disclosure, wherein a Mobile Country Code (MCC), a Mobile Network Code (MNC), a Network Identifier (NID) value, and NID assignment mode information are contained in the SNPN identity or identifier field. FIG. 5C illustrates a diagram of an example format of the SNPN access information field in accordance with some embodiments of the disclosure, wherein ‘CH’ bit indicates whether the SNPN supports access using credentials from a credentials holder, ‘CHWC’ bit indicates whether the SNPN allows registration attempts with credentials from a credentials holder from UEs that are not explicitly configured to select the SNPN, ‘OB’ bit indicates whether the SNPN allows onboarding, and ‘EMS’ bit indicates whether the SNPN supports emergency services. FIG. 5D illustrates a diagram of an example format of the supported GINs field in accordance with some embodiments of the disclosure, wherein GIN identifiers supported by the SNPN are contained in the supported GIN field.

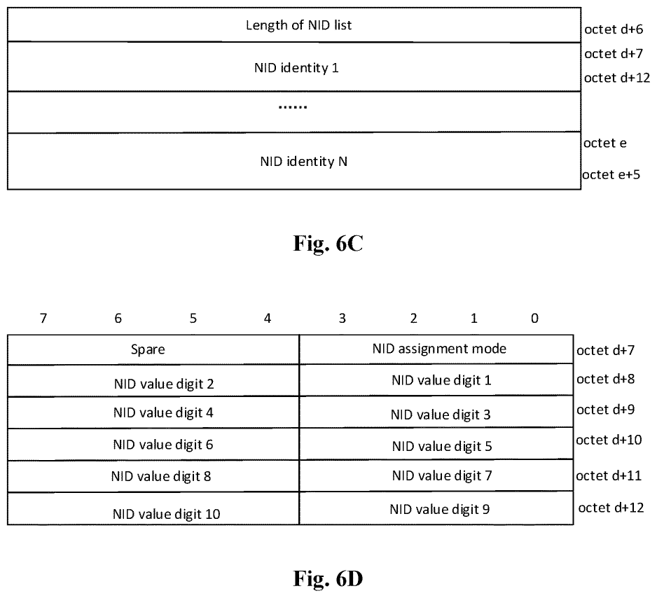

FIG. 6A illustrates a diagram of an example format of the GIN list field in accordance with some embodiments of the disclosure. As shown in FIG. 6A, the GIN list field includes a length of GIN list field and one or more GIN information entry fields, wherein information relevant to one or more GINs supported by the SNPN is contained in the one or more GIN information entry fields. FIG. 6B illustrates a diagram of an example format of the GIN information entry field in accordance with some embodiments of the disclosure, wherein the GIN information entry field includes an MCC, an MNC and a NID list. FIG. 6C illustrates a diagram of an example format of the NID list in accordance with some embodiments of the disclosure, wherein the NID list includes one or more NID identifiers or identities. FIG. 6D illustrates a diagram of an example format of the NID identity in accordance with some embodiments of the disclosure.

In some embodiments, the method 100 for trusted non-3GPP access network selection may further include: creating a prioritized list of available WLANs based on WLAN Selection Policy (WLANSP) rules and receiving the ANQP information element from each WLAN indicated by the prioritized list of available WLANs.

In some embodiments, the UE may obtain the WLANSP rules by pre-configuration or by downloading from a Policy Control Function (PCF) entity of the 5GC network, and the WLANSP rules contain UE access network discovery and selection related policy information to help the UE in discovering and selecting an available WLAN.

In some embodiments, when the UE is not operating in SNPN access mode, the UE may obtain the WLANSP rules from a PLMN. For example, when the UE is in a home PLMN, the UE may obtain the WLANSP rules from the home PLMN and use them to select an available WLAN. For another example, when the UE is roaming and has obtained the WLANSP rules from the home PLMN, a visited PLMN and a PLMN equivalent to the visited PLMN, the UE may use the WLANSP rules in the following order of decreasing priority: a) the WLANSP rules from the visited PLMN; b) the WLANSP rules from the equivalent PLMN in which the UE last received the WLANSP rules; and c) the WLANSP rules from the home PLMN.

In some embodiments, when the UE is operating in SNPN access mode, the UE may receive the WLANSP rules from a credentials holder and use the following WLANSP rules to select an available WLAN: a) if the UE is registered over 3GPP access, the WLANSP rules from a subscribed SNPN or PLMN subscription used for registration over 3GPP access; or b) if the UE is not registered over 3GPP access, the WLANSP rules from a subscribed SNPN or PLMN subscription selected from a list of subscriber data maintained by the UE.

In some embodiments, the UE may perform WLAN selection based on user preferences and the WLANSP rules. When the UE is not operating in SNPN access mode, the UE may be provisioned with the WLANSP rules from multiple PLMNs. When the UE is operating in SNPN access mode, the UE may be provisioned with the WLANSP rules from a credentials holder. The user preferences take precedence over the WLANSP rules.

In some embodiments, when the UE is operating in SNPN access mode and supports access to an SNPN using credentials from a credentials holder: a) if the UE is registered over 3GPP access, the UE may obtain the WLANSP rules from a subscribed SNPN or PLMN subscription used for registration over 3GPP access; or b) if the UE is not registered over 3GPP access, the UE may obtain the WLANSP rules from a subscribed SNPN or PLMN subscription selected from a list of subscriber data maintained by the UE.

In some embodiments, a WLAN may be included in the prioritized list of available WLANs when the UE receives a list of domain names and a list of SNPN identifiers from the WLAN, the list of domain names includes a home network domain name associated with an SNPN identifier included in the PLMN subscription selected from the list of subscriber data maintained by the UE, and the list of SNPN identifiers includes a SNPN identifier associated with the subscribed SNPN.

In some embodiments, the method 100 for trusted non-3GPP access network selection may further include, the UE is operating in SNPN access mode, for each WLAN indicated by the prioritized list of available WLANs: when both the WLAN and the UE supports ANQP, sending an ANQP request message to request a list of Network Access Identifier (NAI) realms or SNPN identifiers associated with the one or more SNPNs with trusted 5G connectivity that can be selected from the WLAN; or when either the WLAN or the UE does not support ANQP, sending an Extensible Authentication Protocol (EAP) response or identity message to request the list of NAI realms or SNPN identifiers associated with the one or more SNPNs with trusted 5G connectivity that can be selected from the WLAN. It should be noted that the list of NAI realms or SNPN identifiers received from the WLAN is of limited size and might not contain all the NAI realms or SNPN identifiers available via the WLAN.

In some embodiments, the method 100 for trusted non-3GPP access network selection may further include: when a NAI realm included in the list of NAI realms or SNPN identifiers is associated with a Registered SNPN (RSNPN) for 3GPP access, if the NAI realm does not match a NAI realm converted from any SNPN identifier included in a temporarily or permanently forbidden SNPNs list for non-3GPP access associated with the PLMN subscription selected from the list of subscriber data maintained by the UE, then selecting the RSNPN for trusted non-3GPP access to the 5GC network, or else selecting, in priority order of entries in the list of NAI realms or SNPN identifiers, a corresponding SNPN for trusted non-3GPP access to the 5GC network.

In some embodiments, the method 100 for trusted non-3GPP access network selection may further include, for each WLAN indicated by the prioritized list of available WLANs:
indicating, to a user of the UE, the one or more SNPNs with trusted 5G connectivity that can be selected from the WLAN for the user to select based on a user preference.

In some embodiments, the method 100 for trusted non-3GPP access network selection may further include: selecting, based on SNPN selection parameters included in the PLMN subscription selected from the list of subscriber data maintained by the UE, the corresponding SNPN for trusted non-3GPP access to the 5GC network; and constructing, based on an SNPN identifier of the selected SNPN, a NAI for trusted access to the selected SNPN.

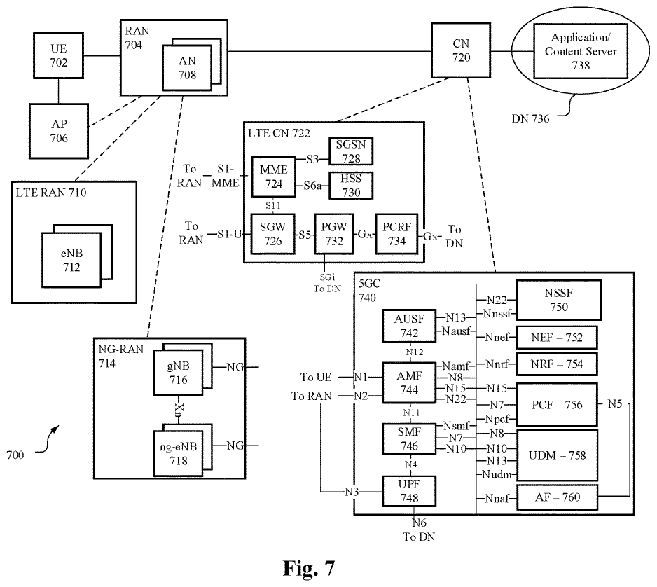

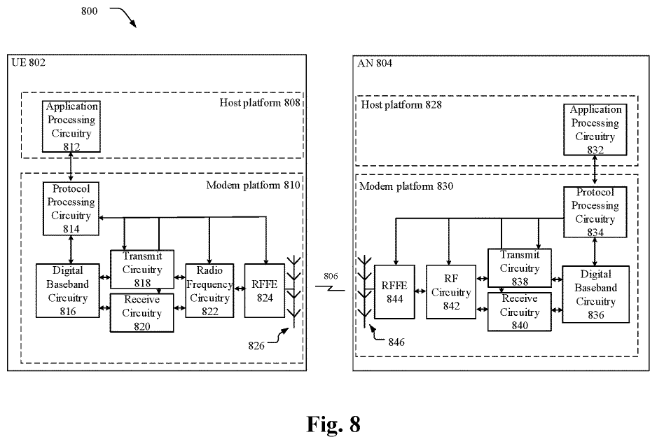

FIGS. 7-8 illustrate various systems, devices, and components that may implement aspects of disclosed embodiments.

FIG. 7 illustrates a diagram of a network 700 in accordance with various embodiments of the disclosure. The network 700 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 700 may include a UE 702, which may include any mobile or non-mobile computing device designed to communicate with a Radio Access Network (RAN) 704 via an over-the-air connection. The UE 702 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 700 may include a plurality of UEs coupled directly with one another via a sidelink interface. The UEs may be M2M/D2D devices that communicate using physical sidelink channels such as, but not limited to, Physical Sidelink Broadcasting Channel (PSBCH), Physical Sidelink Discovery Channel (PSDCH), Physical Sidelink Shared Channel (PSSCH), Physical Sidelink Control Channel (PSCCH), Physical Sidelink Fundamental Channel (PSFCH), etc.

In some embodiments, the UE 702 may additionally communicate with an Access Point (AP) 706 via an over-the-air connection. The AP 706 may manage a WLAN connection, which may serve to offload some/all network traffic from the RAN 704. The connection between the UE 702 and the AP 706 may be consistent with any IEEE 802.11 protocol, wherein the AP 706 could be a wireless fidelity (Wi-Fi®) router. In some embodiments, the UE 702, RAN 704, and AP 706 may utilize cellular-WLAN aggregation (for example, LTE-WLAN Aggregation (LWA)/Light weight IP (LWIP)). Cellular-WLAN aggregation may involve the UE 702 being configured by the RAN 704 to utilize both cellular radio resources and WLAN resources.

The RAN 704 may include one or more access nodes, for example, AN 708. AN 708 may terminate air-interface protocols for the UE 702 by providing access stratum protocols including RRC, Packet Data Convergence Protocol (PDCP), Radio Link Control (RLC), Medium Access Control (MAC), and LI protocols. In this manner, the AN 708 may enable data/voice connectivity between CN 720 and the UE 702. In some embodiments, the AN 708 may be implemented in a discrete device or as one or more software entities running on server computers as part of, for example, a virtual network, which may be referred to as a CRAN or virtual baseband unit pool. The AN 708 be referred to as a BS, gNB, RAN node, eNB, ng-eNB, NodeB, Road Side Unit (RSU), TRxP, TRP, etc. The AN 708 may be a macrocell base station or a low power base station for providing femtocells, picocells or other like cells having smaller coverage areas, smaller user capacity, or higher bandwidth compared to macrocells.

In embodiments in which the RAN 704 includes a plurality of Access Networks (ANs), they may be coupled with one another via an X2 interface (if the RAN 704 is an LTE RAN) or an Xn interface (if the RAN 704 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 704 may each manage one or more cells, cell groups, component carriers, etc. to provide the UE 702 with an air interface for network access. The UE 702 may be simultaneously connected with a plurality of cells provided by the same or different ANs of the RAN 704. For example, the UE 702 and RAN 704 may use carrier aggregation to allow the UE 702 to connect with a plurality of component carriers, each corresponding to a Primary cell (Pcell) or Secondary cell (Scell). In dual connectivity scenarios, a first AN may be a master node that provides a Master Cell Group (MCG) and a second AN may be secondary node that provides a Secondary Cell Group (SCG). The first/second ANs may be any combination of eNB, gNB, ng-eNB, etc.

The RAN 704 may provide the air interface over a licensed spectrum or an unlicensed spectrum. To operate in the unlicensed spectrum, the nodes may use Licensed Assisted Access (LAA), enhanced LAA (eLAA), and/or further enhanced LAA (feLAA) mechanisms based on Carrier Aggregation (CA) technology with PCells/Scells. Prior to accessing the unlicensed spectrum, the nodes may perform medium/carrier-sensing operations based on, for example, a listen-before-talk (LBT) protocol.

In Vehicle-to-everything (V2X) scenarios, the UE 702 or AN 708 may be or act as a Road Side Unit (RSU), which may refer to any transportation infrastructure entity used for V2X communications. An RSU may be implemented in or by a suitable AN or a stationary (or relatively stationary) UE. An RSU implemented in or by a UE may be referred to as a “UE-type RSU”; an eNB may be referred to as an “eNB-type RSU”; a next-generation NodeB (gNB) may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 704 may be an LTE RAN 710 with evolved NodeBs (eNBs), for example, eNB 712. The LTE RAN 710 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH Demodulation Reference Signal (DMRS) for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 704 may be a Next Generation (NG)-RAN 714 with gNBs, for example, gNB 716, or ng-eNBs, for example, ng-eNB 718. The gNB 716 may connect with 5G-enabled UEs using a 5G NR interface. The gNB 716 may connect with a 5G core through an NG interface, which may include an N2 interface or an N3 interface. The ng-eNB 718 may also connect with the 5G core through an NG interface, but may connect with a UE via an LTE air interface. The gNB 716 and the ng-eNB 718 may connect with each other over an Xn interface.

In some embodiments, the NG interface may be split into two parts, an NG user plane (NG-U) interface, which carries traffic data between the nodes of the NG-RAN 714 and a UPF 748 (e.g., N3 interface), and an NG control plane (NG-C) interface, which is a signaling interface between the nodes of the NG-RAN 714 and an Access and Mobility Management Function (AMF) 744 (e.g., N2 interface).

The NG-RAN 714 may provide a 5G-NR air interface with the following characteristics:
variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FRI bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 702 can be configured with multiple BWPs where each BWP configuration has a different SCS. When a BWP change is indicated to the UE 702, the SCS of the transmission is changed as well. Another use case example of BWP is related to power saving. In particular, multiple BWPs can be configured for the UE 702 with different amount of frequency resources (for example, PRBs) to support data transmission under different traffic loading scenarios. A BWP containing a smaller number of PRBs can be used for data transmission with small traffic load while allowing power saving at the UE 702 and in some cases at the gNB 716. A BWP containing a larger number of PRBs can be used for scenarios with higher traffic load.

The RAN 704 is communicatively coupled to CN 720 that includes network elements to provide various functions to support data and telecommunications services to customers/subscribers (for example, users of UE 702). The components of the CN 720 may be implemented in one physical node or separate physical nodes. In some embodiments, NFV may be utilized to virtualize any or all of the functions provided by the network elements of the CN 720 onto physical compute/storage resources in servers, switches, etc. A logical instantiation of the CN 720 may be referred to as a network slice, and a logical instantiation of a portion of the CN 720 may be referred to as a network sub-slice.

In some embodiments, the CN 720 may be an LTE CN 722, which may also be referred to as an EPC. The LTE CN 722 may include Mobility Management Entity (MME) 724, Serving Gateway (SGW) 726, Serving GPRS Support Node (SGSN) 728, Home Subscriber Server (HSS) 730, Proxy Gateway (PGW) 732, and Policy Control and Charging Rules Function (PCRF) 734 coupled with one another over interfaces (or “reference points”) as shown. Functions of the elements of the LTE CN 722 may be briefly introduced as follows.

The MME 724 may implement mobility management functions to track a current location of the UE 702 to facilitate paging, bearer activation/deactivation, handovers, gateway selection, authentication, etc.

The SGW 726 may terminate an SI interface toward the RAN and route data packets between the RAN and the LTE CN 722. The SGW 726 may be a local mobility anchor point for inter-RAN node handovers and also may provide an anchor for inter-3GPP mobility. Other responsibilities may include lawful intercept, charging, and some policy enforcement.

The SGSN 728 may track a location of the UE 702 and perform security functions and access control. In addition, the SGSN 728 may perform inter-EPC node signaling for mobility between different RAT networks; PDN and S-GW selection as specified by MME 724; MME selection for handovers; etc. The S3 reference point between the MME 724 and the SGSN 728 may enable user and bearer information exchange for inter-3GPP access network mobility in idle/active states.

The HSS 730 may include a database for network users, including subscription-related information to support the network entities'handling of communication sessions. The HSS 730 can provide support for routing/roaming, authentication, authorization, naming/addressing resolution, location dependencies, etc. An S6a reference point between the HSS 730 and the MME 724 may enable transfer of subscription and authentication data for authenticating/authorizing user access to the LTE CN 720.

The PGW 732 may terminate a SGi interface toward a data network (DN) 736 that may include an application/content server 738. The PGW 732 may route data packets between the LTE CN 722 and the data network 736. The PGW 732 may be coupled with the SGW 726 by an S5 reference point to facilitate user plane tunneling and tunnel management. The PGW 732 may further include a node for policy enforcement and charging data collection (for example, PCEF). Additionally, the SGi reference point between the PGW 732 and the data network 736 may be an operator external public, a private PDN, or an intra-operator packet data network, for example, for provision of IMS services. The PGW 732 may be coupled with a PCRF 734 via a Gx reference point.

The PCRF 734 is the policy and charging control element of the LTE CN 722. The PCRF 734 may be communicatively coupled to the application/content server 738 to determine appropriate QoS and charging parameters for service flows. The PCRF 732 may provision associated rules into a PCEF (via Gx reference point) with appropriate TFT and QCI.

In some embodiments, the CN 720 may be a 5G Core network (5GC) 740. The 5GC 740 may include an Authentication Server Function (AUSF) 742, Access and Mobility Management Function (AMF) 744, Session Management Function (SMF) 746, User Plane Function (UPF) 748, Network Slice Selection Function (NSSF) 750, Network Exposure Function (NEF) 752, NF Repository Function (NRF) 754, Policy Control Function (PCF) 756, Unified Data Management (UDM) 758, and Application Function (AF) 760 coupled with one another over interfaces (or “reference points”) as shown. Functions of the elements of the 5GC 740 may be briefly introduced as follows.

The AUSF 742 may store data for authentication of UE 702 and handle authentication-related functionality. The AUSF 742 may facilitate a common authentication framework for various access types. In addition to communicating with other elements of the 5GC 740 over reference points as shown, the AUSF 742 may exhibit a Nausf service-based interface.

The AMF 744 may allow other functions of the 5GC 740 to communicate with the UE 702 and the RAN 704 and to subscribe to notifications about mobility events with respect to the UE 702. The AMF 744 may be responsible for registration management (for example, for registering UE 702), connection management, reachability management, mobility management, lawful interception of AMF-related events, and access authentication and authorization. The AMF 744 may provide transport for Session Management (SM) messages between the UE 702 and the SMF 746, and act as a transparent proxy for routing SM messages. AMF 744 may also provide transport for SMS messages between UE 702 and an SMSF. AMF 744 may interact with the AUSF 742 and the UE 702 to perform various security anchor and context management functions. Furthermore, AMF 744 may be a termination point of a RAN CP interface, which may include or be an N2 reference point between the RAN 704 and the AMF 744; and the AMF 744 may be a termination point of NAS (N1) signaling, and perform NAS ciphering and integrity protection. AMF 744 may also support NAS signaling with the UE 702 over an N3 IWF interface.

The SMF 746 may be responsible for SM (for example, session establishment, tunnel management between UPF 748 and AN 708); UE IP address allocation and management (including optional authorization); selection and control of UP function; configuring traffic steering at UPF 748 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 744 over N2 to AN 708; and determining SSC mode of a session. SM may refer to management of a PDU session, and a PDU session or “session” may refer to a PDU connectivity service that provides or enables the exchange of PDUs between the UE 702 and the data network 736.

The UPF 748 may act as an anchor point for intra-RAT and inter-RAT mobility, an external PDU session point of interconnect to data network 736, and a branching point to support multi-homed PDU session. The UPF 748 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 748 may include an uplink classifier to support routing traffic flows to a data network.

The NSSF 750 may select a set of network slice instances serving the UE 702. The NSSF 750 may also determine allowed Network Slice Selection Assistance Information (NSSAI) and the mapping to the subscribed Single-NSSAIs (S-NSSAIs), if needed. The NSSF 750 may also determine the AMF set to be used to serve the UE 702, or a list of candidate AMFs based on a suitable configuration and possibly by querying the NRF 754. The selection of a set of network slice instances for the UE 702 may be triggered by the AMF 744 with which the UE 702 is registered by interacting with the NSSF 750, which may lead to a change of AMF. The NSSF 750 may interact with the AMF 744 via an N22 reference point; and may communicate with another NSSF in a visited network via an N31 reference point (not shown). Additionally, the NSSF 750 may exhibit an Nnssf service-based interface.

The NEF 752 may securely expose services and capabilities provided by 3GPP network functions for third party, internal exposure/re-exposure, AFs (e.g., AF 760), edge computing or fog computing systems, etc. In such embodiments, the NEF 752 may authenticate, authorize, or throttle the AFs. NEF 752 may also translate information exchanged with the AF 760 and information exchanged with internal network functions. For example, the NEF 752 may translate between an AF-Service-Identifier and an internal 5GC information. NEF 752 may also receive information from other NFs based on exposed capabilities of other NFs. This information may be stored at the NEF 752 as structured data, or at a data storage NF using standardized interfaces. The stored information can then be re-exposed by the NEF 752 to other NFs and AFs, or used for other purposes such as analytics. Additionally, the NEF 752 may exhibit a Nnef service-based interface.

The NRF 754 may support service discovery functions, receive NF discovery requests from NF instances, and provide the information of the discovered NF instances to the NF instances. NRF 754 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 754 may exhibit the Nnrf service-based interface.

The PCF 756 may provide policy rules to control plane functions to enforce them, and may also support unified policy framework to govern network behavior. The PCF 756 may also implement a front end to access subscription information relevant for policy decisions in a UDR of the UDM 758. In addition to communicating with functions over reference points as shown, the PCF 756 exhibit an Npcf service-based interface.

The UDM 758 may handle subscription-related information to support the network entities'handling of communication sessions, and may store subscription data of UE 702. For example, subscription data may be communicated via an N8 reference point between the UDM 758 and the AMF 744. The UDM 758 may include two parts, an application front end and a UDR. The UDR may store subscription data and policy data for the UDM 758 and the PCF 756, and/or structured data for exposure and application data (including PFDs for application detection, application request information for multiple UEs 702) for the NEF 752. The Nudr service-based interface may be exhibited by the UDR to allow the UDM 758, PCF 756, and NEF 752 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 758 may exhibit the Nudm service-based interface.

The AF 760 may provide application influence on traffic routing, provide access to NEF, and interact with the policy framework for policy control.

In some embodiments, the 5GC 740 may enable edge computing by selecting operator/3rd party services to be geographically close to a point that the UE 702 is attached to the network. This may reduce latency and load on the network. To provide edge-computing implementations, the 5GC 740 may select a UPF 748 close to the UE 702 and execute traffic steering from the UPF 748 to data network 736 via the N6 interface. This may be based on the UE subscription data, UE location, and information provided by the AF 760. In this way, the AF 760 may influence UPF (re)selection and traffic routing. Based on operator deployment, when AF 760 is considered to be a trusted entity, the network operator may permit AF 760 to interact directly with relevant NFs. Additionally, the AF 760 may exhibit a Naf service-based interface.

The data network 736 may represent various network operator services, Internet access, or third party services that may be provided by one or more servers including, for example, application/content server 738.

FIG. 8 illustrates a wireless network 800 in accordance with various embodiments of the disclosure. The wireless network 800 may include a UE 802 in wireless communication with an AN 804. The UE 802 and AN 804 may be similar to, and substantially interchangeable with, like-named components described elsewhere herein.

The UE 802 may be communicatively coupled with the AN 804 via connection 806. The connection 806 is illustrated as an air interface to enable communicative coupling, and can be consistent with cellular communications protocols such as an LTE protocol or a 5G NR protocol operating at mmWave or sub-6 GHz frequencies.

The UE 802 may include a host platform 808 coupled with a modem platform 810. The host platform 808 may include application processing circuitry 812, which may be coupled with protocol processing circuitry 814 of the modem platform 810. The application processing circuitry 812 may run various applications for the UE 802 that source/sink application data. The application processing circuitry 812 may further implement one or more layer operations to transmit/receive application data to/from a data network. These layer operations may include transport (for example UDP) and Internet (for example, IP) operations.

The protocol processing circuitry 814 may implement one or more of layer operations to facilitate transmission or reception of data over the connection 806. The layer operations implemented by the protocol processing circuitry 814 may include, for example, MAC, RLC, PDCP, RRC and NAS operations.

The modem platform 810 may further include digital baseband circuitry 816 that may implement one or more layer operations that are “below” layer operations performed by the protocol processing circuitry 814 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 810 may further include transmit circuitry 818, receive circuitry 820, RF circuitry 822, and RF front end (RFFE) circuit 824, which may include or connect to one or more antenna panels 826. Briefly, the transmit circuitry 818 may include a digital-to-analog converter, mixer, intermediate frequency (IF) components, etc. ; the receive circuitry 820 may include an analog-to-digital converter, mixer, IF components, etc. ; the RF circuitry 822 may include a low-noise amplifier, a power amplifier, power tracking components, etc. ; RFFE circuit 824 may include filters (for example, surface/bulk acoustic wave filters), switches, antenna tuners, beamforming components (for example, phase-array antenna components), etc. The selection and arrangement of the components of the transmit circuitry 818, receive circuitry 820, RF circuitry 822, RFFE circuit 824, and antenna panels 826 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 814 may include one or more instances of control circuitry (not shown) to provide control functions for the transmit/receive components.

A UE reception may be established by and via the antenna panels 826, RFFE circuit 824, RF circuitry 822, receive circuitry 820, digital baseband circuitry 816, and protocol processing circuitry 814. In some embodiments, the antenna panels 826 may receive a transmission from the AN 804 by receiving beamforming signals received by a plurality of antennas/antenna elements of the one or more antenna panels 826.

A UE transmission may be established by and via the protocol processing circuitry 814, digital baseband circuitry 816, transmit circuitry 818, RF circuitry 822, RFFE circuitry 824, and antenna panels 826. In some embodiments, the transmit components of the UE 804 may apply a spatial filter to the data to be transmitted to form a transmit beam emitted by the antenna elements of the antenna panels 826.

Similar to the UE 802, the AN 804 may include a host platform 828 coupled with a modem platform 830. The host platform 828 may include application processing circuitry 832 coupled with protocol processing circuitry 834 of the modem platform 830. The modem platform may further include digital baseband circuitry 836, transmit circuitry 838, receive circuitry 840, RF circuitry 842, RFFE circuitry 844, and antenna panels 846. The components of the AN 804 may be similar to and substantially interchangeable with like-named components of the UE 802. In addition to performing data transmission/reception as described above, the components of the AN 808 may perform various logical functions that include, for example, RNC functions such as radio bearer management, uplink and downlink dynamic radio resource management, and data packet scheduling.

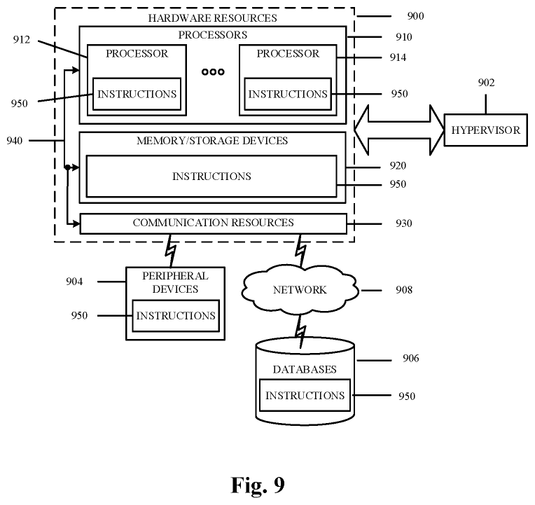

FIG. 9 illustrates a block diagram of components, according to some example embodiments of the disclosure, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors (or processor cores) 910, one or more memory/storage devices 920, and one or more communication resources 930, each of which may be communicatively coupled via a bus 940 or other interface circuitry. For embodiments where node virtualization (e.g., Network Function Virtualization (NFV)) is utilized, a hypervisor 902 may be executed to provide an execution environment for one or more network slices/sub-slices to utilize the hardware resources 900.

The processors 910 may include, for example, a processor 912 and a processor 914. The processors 910 may be, for example, a central processing unit (CPU), a reduced instruction set computing (RISC) processor, a complex instruction set computing (CISC) processor, a graphics processing unit (GPU), a DSP such as a baseband processor, an Application Specific Integrated Circuit (ASIC), an Field Programmable Gate Array (FPGA), a radio-frequency integrated circuit (RFIC), another processor (including those discussed herein), or any suitable combination thereof.

The memory/storage devices 920 may include main memory, disk storage, or any suitable combination thereof. The memory/storage devices 920 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 930 may include interconnection or network interface controllers, components, or other suitable devices to communicate with one or more peripheral devices 904 or one or more databases 906 or other network elements via a network 908. For example, the communication resources 930 may include wired communication components (e.g., for coupling via USB, Ethernet, etc.), cellular communication components, NFC components, Bluetooth® (or Bluetooth® Low Energy) components, Wi-Fi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

The following paragraphs describe examples of various embodiments.

Example 1 includes an apparatus for trusted non-3GPP access network selection, wherein the apparatus is used in User Equipment (UE) and comprises processor circuitry configured to cause the UE to, when the UE is operating in Stand-alone Non-Public Network (SNPN) access mode: receive, from a Wireless Local Area Network (WLAN), an Access Network Query Protocol (ANQP) information element, wherein the ANQP information element is an SNPN list with trusted 5G connectivity information element indicating one or more SNPNs with trusted 5G connectivity that can be selected from the WLAN; and select, based on the SNPN list with trusted 5G connectivity information element, a SNPN with trusted 5G connectivity for trusted non-3GPP access to a 5G Core (5GC) network.

Example 2 includes the apparatus of Example 1, wherein the SNPN list with trusted 5G connectivity information element contains a SNPN identifier associated with each of the one or more SNPNs with trusted 5G connectivity that can be selected from the WLAN.

Example 3 includes the apparatus of Example 1, wherein the SNPN list with trusted 5G connectivity information element contains one or more Group Identifiers for Network selection (GINs) supported by each of the one or more SNPNs with trusted 5G connectivity that can be selected from the WLAN.

Example 4 includes the apparatus of Example 1, wherein the SNPN list with trusted 5G connectivity information element contains SNPN access information associated with each of the one or more SNPNs with trusted 5G connectivity that can be selected from the WLAN.

Example 5 includes the apparatus of Example 1, wherein the SNPN list with trusted 5G connectivity information element contains, for each of the one or more SNPNs with trusted 5G connectivity that can be selected from the WLAN, information indicating whether the SNPN supports access using credentials from a credentials holder.

Example 6 includes the apparatus of Example 1, wherein the SNPN list with trusted 5G connectivity information element contains, for each of the one or more SNPNs with trusted 5G connectivity that can be selected from the WLAN, information indicating whether the SNPN allows registration attempts with credentials from a credentials holder from UEs that are not explicitly configured to select the SNPN.

Example 7 includes the apparatus of Example 1, wherein the SNPN list with trusted 5G connectivity information element contains, for each of the one or more SNPNs with trusted 5G connectivity that can be selected from the WLAN, information indicating whether the SNPN supports SNPN onboarding services.

Example 8 includes the apparatus of Example 1, wherein the SNPN list with trusted 5G connectivity information element contains, for each of the one or more SNPNs with trusted 5G connectivity that can be selected from the WLAN, information indicating whether the SNPN supports emergency services.

Example 9 includes the apparatus of Example 1, wherein the processor circuitry is further configured to cause the UE to create a prioritized list of available WLANs based on WLAN Selection Policy (WLANSP) rules and receive the ANQP information element from each WLAN indicated by the prioritized list of available WLANs.

Example 10 includes the apparatus of Example 9, wherein when the UE is not operating in SNPN access mode, the WLANSP rules are obtained from a Public Land Mobile Network (PLMN).

Example 11 includes the apparatus of Example 9, wherein when the UE is operating in SNPN access mode and supports access to an SNPN using credentials from a credential holder, the WLANSP rules are obtained from the credentials holder.

Example 12 includes the apparatus of Example 11, wherein the processor circuitry is further configured to cause the UE to, for each WLAN indicated by the prioritized list of available WLANs: when both the WLAN and the UE supports ANQP, send an ANQP request message to request a list of Network Access Identifier (NAI) realms or SNPN identifiers associated with the one or more SNPNs with trusted 5G connectivity that can be selected from the WLAN; or when either the WLAN or the UE does not support ANQP, send an Extensible Authentication Protocol (EAP) response or identity message to request the list of NAI realms or SNPN identifiers associated with the one or more SNPNs with trusted 5G connectivity that can be selected from the WLAN.

Example 13 includes the apparatus of Example 12, wherein the processor circuitry is further configured to cause the UE to, for each WLAN indicated by the prioritized list of available WLANs: indicate, to a user of the UE, the one or more SNPNs with trusted 5G connectivity that can be selected from the WLAN for the user to select based on a user preference.

Example 14 includes the apparatus of Example 12, wherein when the UE is registered over 3GPP access, the WLANSP rules are obtained from a subscribed SNPN or PLMN subscription used for registration over 3GPP access.

Example 15 includes the apparatus of Example 12, wherein when the UE is not registered over 3GPP access, the WLANSP rules are obtained from a subscribed SNPN or PLMN subscription selected from a list of subscriber data maintained by the UE.

Example 16 includes the apparatus of Example 14 or 15, wherein a WLAN is included in the prioritized list of available WLANs when the UE receives a list of domain names and a list of SNPN identifiers from the WLAN, the list of domain names includes a home network domain name associated with an SNPN identifier included in the PLMN subscription, and the list of SNPN identifiers includes a SNPN identifier associated with the subscribed SNPN.

Example 17 includes the apparatus of Example 14, wherein the processor circuitry is further configured to cause the UE to: when a NAI realm included in the list of NAI realms or SNPN identifiers is associated with a Registered SNPN (RSNPN) for 3GPP access, if the NAI realm does not match a NAI realm converted from any SNPN identifier included in a temporarily or permanently forbidden SNPNs list for non-3GPP access associated with the PLMN subscription, then select the RSNPN for trusted non-3GPP access to the 5GC network, or else select, in priority order of entries in the list of NAI realms or SNPN identifiers, a corresponding SNPN for trusted non-3GPP access to the 5GC network.

Example 18 includes the apparatus of Example 15, wherein the processor circuitry is further configured to cause the UE to: select, based on SNPN selection parameters included in the PLMN subscription, the corresponding SNPN for trusted non-3GPP access to the 5GC network.

Example 19 includes the apparatus of Example 12, wherein the processor circuitry is further configured to cause the UE to: construct, based on an SNPN identifier of the selected SNPN, a NAI for trusted access to the selected SNPN.

Example 20 includes a method for trusted non-3GPP access network selection, wherein the method is used in User Equipment (UE) and comprises, when the UE is operating in Stand-alone Non-Public Network (SNPN) access mode: receiving, from a Wireless Local Area Network (WLAN), an Access Network Query Protocol (ANQP) information element, wherein the ANQP information element is an SNPN list with trusted 5G connectivity information element indicating one or more SNPNs with trusted 5G connectivity that can be selected from the WLAN; and selecting, based on the SNPN list with trusted 5G connectivity information element, a SNPN with trusted 5G connectivity for trusted non-3GPP access to a 5G Core (5GC) network.

Example 21 includes the method of Example 20, wherein the SNPN list with trusted 5G connectivity information element contains a SNPN identifier associated with each of the one or more SNPNs with trusted 5G connectivity that can be selected from the WLAN.

Example 22 includes the method of Example 20, wherein the SNPN list with trusted 5G connectivity information element contains one or more Group Identifiers for Network selection (GINs) supported by each of the one or more SNPNs with trusted 5G connectivity that can be selected from the WLAN.

Example 23 includes the method of Example 20, wherein the SNPN list with trusted 5G connectivity information element contains SNPN access information associated with each of the one or more SNPNs with trusted 5G connectivity that can be selected from the WLAN.

Example 24 includes the method of Example 20, wherein the SNPN list with trusted 5G connectivity information element contains, for each of the one or more SNPNs with trusted 5G connectivity that can be selected from the WLAN, information indicating whether the SNPN supports access using credentials from a credentials holder.

Example 25 includes the method of Example 20, wherein the SNPN list with trusted 5G connectivity information element contains, for each of the one or more SNPNs with trusted 5G connectivity that can be selected from the WLAN, information indicating whether the SNPN allows registration attempts with credentials from a credentials holder from UEs that are not explicitly configured to select the SNPN.

Example 26 includes the method of Example 20, wherein the SNPN list with trusted 5G connectivity information element contains, for each of the one or more SNPNs with trusted 5G connectivity that can be selected from the WLAN, information indicating whether the SNPN supports SNPN onboarding services.

Example 27 includes the method of Example 20, wherein the SNPN list with trusted 5G connectivity information element contains, for each of the one or more SNPNs with trusted 5G connectivity that can be selected from the WLAN, information indicating whether the SNPN supports emergency services.

Example 28 includes the method of Example 20, wherein the method further comprises creating a prioritized list of available WLANs based on WLAN Selection Policy (WLANSP) rules and receiving the ANQP information element from each WLAN indicated by the prioritized list of available WLANs.

Example 29 includes the method of Example 28, wherein when the UE is not operating in SNPN access mode, the WLANSP rules are obtained from a Public Land Mobile Network (PLMN).

Example 30 includes the method of Example 28, wherein when the UE is operating in SNPN access mode and supports access to an SNPN using credentials from a credential holder, the WLANSP rules are obtained from the credentials holder.

Example 31 includes the method of Example 30, wherein the method further comprises, for each WLAN indicated by the prioritized list of available WLANs: when both the WLAN and the UE supports ANQP, sending an ANQP request message to request a list of Network Access Identifier (NAI) realms or SNPN identifiers associated with the one or more SNPNs with trusted 5G connectivity that can be selected from the WLAN; or when either the WLAN or the UE does not support ANQP, sending an Extensible Authentication Protocol (EAP) response or identity message to request the list of NAI realms or SNPN identifiers associated with the one or more SNPNs with trusted 5G connectivity that can be selected from the WLAN.

Example 32 includes the method of Example 31, wherein the method further comprises, for each WLAN indicated by the prioritized list of available WLANs: indicating, to a user of the UE, the one or more SNPNs with trusted 5G connectivity that can be selected from the WLAN for the user to select based on a user preference.

Example 33 includes the method of Example 31, wherein when the UE is registered over 3GPP access, the WLANSP rules are obtained from a subscribed SNPN or PLMN subscription used for registration over 3GPP access.

Example 34 includes the method of Example 31, wherein when the UE is not registered over 3GPP access, the WLANSP rules are obtained from a subscribed SNPN or PLMN subscription selected from a list of subscriber data maintained by the UE.

Example 35 includes the method of Example 33 or 34, wherein a WLAN is included in the prioritized list of available WLANs when the UE receives a list of domain names and a list of SNPN identifiers from the WLAN, the list of domain names includes a home network domain name associated with an SNPN identifier included in the PLMN subscription, and the list of SNPN identifiers includes a SNPN identifier associated with the subscribed SNPN.

Example 36 includes the method of Example 33, wherein the method further comprises: when a NAI realm included in the list of NAI realms or SNPN identifiers is associated with a Registered SNPN (RSNPN) for 3GPP access, if the NAI realm does not match a NAI realm converted from any SNPN identifier included in a temporarily or permanently forbidden SNPNs list for non-3GPP access associated with the PLMN subscription, then selecting the RSNPN for trusted non-3GPP access to the 5GC network, or else selecting, in priority order of entries in the list of NAI realms or SNPN identifiers, a corresponding SNPN for trusted non-3GPP access to the 5GC network.

Example 37 includes the method of Example 34, wherein the method further comprises: selecting, based on SNPN selection parameters included in the PLMN subscription, the corresponding SNPN for trusted non-3GPP access to the 5GC network.

Example 38 includes the method of Example 31, wherein the method further comprises: constructing, based on an SNPN identifier of the selected SNPN, a NAI for trusted access to the selected SNPN.

Example 39 includes an apparatus for trusted non-3GPP access network selection, comprising means for implementing the method of any one of Examples 20-38.

Example 40 includes User Equipment (UE), comprising the apparatus of any one of Examples 1-19.

Example 41 includes User Equipment (UE), comprising means for implementing the method of any one of Examples 20-38.

Although certain embodiments have been illustrated and described herein for purposes of description, a wide variety of alternate and/or equivalent embodiments or implementations to achieve the same purposes may be substituted for the embodiments shown and described without departing from the scope of the present disclosure. This application is intended to cover any adaptations or variations of the embodiments discussed herein. Therefore, it is manifestly intended that embodiments described herein are limited by the appended claims and the equivalents thereof.

1-20. (canceled)

21. An apparatus for trusted non-3GPP access network selection, wherein the apparatus is used in User Equipment (UE) and comprises processor circuitry configured to cause the UE to, when the UE is operating in Stand-alone Non-Public Network (SNPN) access mode:
receive, from a Wireless Local Area Network (WLAN), an Access Network Query Protocol (ANQP) information element, wherein the ANQP information element is an SNPN list with trusted 5G connectivity information element indicating one or more SNPNs with trusted 5G connectivity that can be selected from the WLAN; and
select, based on the SNPN list with trusted 5G connectivity information element, a SNPN with trusted 5G connectivity for trusted non-3GPP access to a 5G Core (5GC) network.

22. The apparatus of claim 21, wherein the SNPN list with trusted 5G connectivity information element contains a SNPN identifier associated with each of the one or more SNPNs with trusted 5G connectivity that can be selected from the WLAN.

23. The apparatus of claim 21, wherein the SNPN list with trusted 5G connectivity information element contains one or more Group Identifiers for Network selection (GINs) supported by each of the one or more SNPNs with trusted 5G connectivity that can be selected from the WLAN.

24. The apparatus of claim 21, wherein the SNPN list with trusted 5G connectivity information element contains SNPN access information associated with each of the one or more SNPNs with trusted 5G connectivity that can be selected from the WLAN.

25. The apparatus of claim 21, wherein the SNPN list with trusted 5G connectivity information element contains, for each of the one or more SNPNs with trusted 5G connectivity that can be selected from the WLAN, information indicating whether the SNPN supports access using credentials from a credentials holder.

26. The apparatus of claim 21, wherein the SNPN list with trusted 5G connectivity information element contains, for each of the one or more SNPNs with trusted 5G connectivity that can be selected from the WLAN, information indicating whether the SNPN allows registration attempts with credentials from a credentials holder from UEs that are not explicitly configured to select the SNPN.

27. The apparatus of claim 21, wherein the SNPN list with trusted 5G connectivity information element contains, for each of the one or more SNPNs with trusted 5G connectivity that can be selected from the WLAN, information indicating whether the SNPN supports SNPN onboarding services.

28. The apparatus of claim 21, wherein the SNPN list with trusted 5G connectivity information element contains, for each of the one or more SNPNs with trusted 5G connectivity that can be selected from the WLAN, information indicating whether the SNPN supports emergency services.

29. The apparatus of claim 21, wherein the processor circuitry is further configured to cause the UE to create a prioritized list of available WLANs based on WLAN Selection Policy (WLANSP) rules and receive the ANQP information element from each WLAN indicated by the prioritized list of available WLANs.

30. The apparatus of claim 29, wherein when the UE is not operating in SNPN access mode, the WLANSP rules are obtained from a Public Land Mobile Network (PLMN).

31. The apparatus of claim 29, wherein when the UE is operating in SNPN access mode and supports access to an SNPN using credentials from a credential holder, the WLANSP rules are obtained from the credentials holder.

32. The apparatus of claim 31, wherein the processor circuitry is further configured to cause the UE to, for each WLAN indicated by the prioritized list of available WLANs:
when both the WLAN and the UE supports ANQP, send an ANQP request message to request a list of Network Access Identifier (NAI) realms or SNPN identifiers associated with the one or more SNPNs with trusted 5G connectivity that can be selected from the WLAN; or
when either the WLAN or the UE does not support ANQP, send an Extensible Authentication Protocol (EAP) response or identity message to request the list of NAI realms or SNPN identifiers associated with the one or more SNPNs with trusted 5G connectivity that can be selected from the WLAN.

33. The apparatus of claim 32, wherein the processor circuitry is further configured to cause the UE to, for each WLAN indicated by the prioritized list of available WLANs:
indicate, to a user of the UE, the one or more SNPNs with trusted 5G connectivity that can be selected from the WLAN for the user to select based on a user preference.

34. The apparatus of claim 32, wherein when the UE is registered over 3GPP access, the WLANSP rules are obtained from a subscribed SNPN or PLMN subscription used for registration over 3GPP access.

35. The apparatus of claim 32, wherein when the UE is not registered over 3GPP access, the WLANSP rules are obtained from a subscribed SNPN or PLMN subscription selected from a list of subscriber data maintained by the UE.

36. The apparatus of claim 34, wherein a WLAN is included in the prioritized list of available WLANs when the UE receives a list of domain names and a list of SNPN identifiers from the WLAN, the list of domain names includes a home network domain name associated with an SNPN identifier included in the PLMN subscription, and the list of SNPN identifiers includes a SNPN identifier associated with the subscribed SNPN.

37. The apparatus of claim 34, wherein the processor circuitry is further configured to cause the UE to:
when a NAI realm included in the list of NAI realms or SNPN identifiers is associated with a Registered SNPN (RSNPN) for 3GPP access, if the NAI realm does not match a NAI realm converted from any SNPN identifier included in a temporarily or permanently forbidden SNPNs list for non-3GPP access associated with the PLMN subscription, then select the RSNPN for trusted non-3GPP access to the 5GC network, or else select, in priority order of entries in the list of NAI realms or SNPN identifiers, a corresponding SNPN for trusted non-3GPP access to the 5GC network.

38. The apparatus of claim 35, wherein the processor circuitry is further configured to cause the UE to:
select, based on SNPN selection parameters included in the PLMN subscription, the corresponding SNPN for trusted non-3GPP access to the 5GC network.

39. The apparatus of claim 32, wherein the processor circuitry is further configured to cause the UE to:
construct, based on an SNPN identifier of the selected SNPN, a NAI for trusted access to the selected SNPN.

40. User Equipment, comprising the apparatus of the claim 21.
